(19) United States
(12) Patent Application Publication
(10) Pub. No.: US 2013/0068879 A1
(43) Pub. Date: Mar. 21, 2013

(54) WING-IN-GROUND EFFECT VESSEL

(71) Applicant: Hokan Colting, Newmarket (CA)

(72) Inventor: Hokan Colting, Newmarket (CA)

(21) Appl. No.: 13/233,545

(22) Filed: Sep. 15, 2011

(51) Int. Cl. B64B 1/20; B64C 17/08; B64B 1/24; B64B 1/22; B64B 1/70; B64B 1/68

(52) U.S. Cl. 244/25; 244/93

(57) ABSTRACT

A WIG (wing in ground effect) vessel includes a hull with wings attached. The WIG vessel includes means for propulsion as well as altitude and directional control. The lift of the wings in ground effect is augmented by partial aerostatic lift, achieved through interior gas holding envelopes containing a lighter-than-air gas. The wings have a high mean chord length, for example fourteen meters or more, allowing the vessel to fly in ground effect above water at an altitude where waves are of minimal concern. The vessel has a low wing loading, below 1.5 kg/m², and the wings are of uniform thickness and have an aspect ratio of less than 1. The conical fore end of the hull forces air below the surface of the wings for ground effect. Weight transfer is used to alter the pitch of the vessel.

### BACKGROUND

1. Field of the Invention

The present invention relates generally to a WIG (Wing In Ground Effect) craft or vessel, and more particularly to a WIG vessel with extremely long chord of the wings or lifting surface and with the ground effect lift augmented by partial aerostatic lift.

2. Description of Related Art

WIG vessels operate under a peculiar aerodynamic phenomenon known as the ground effect. The ground effect occurs when a wing operates near a surface where it creates, and floats on, a cushion of high-pressure air due to the aerodynamic interaction between the wings and the surface, resulting in increased lift by the wing.

A WIG vessel is a hybrid, part boat and part aircraft combining marine, aviation, wing, air cushion, aerodynamic and hydrodynamic theories. The IMO (International Maritime Organization) categorizes WIG vessels as type A, B or C. Type A and B are licensed as marine vessels and operate under IMO rules.

The principles of WIG vessels have been known for more than 50 years. Most WIG vessels are based on airplane designs and subject to a number of difficult to solve, technical issues, that have prevented any widespread commercial operations.

An example of an airplane-based WIG vessel is U.S. Pat. No. 6,029,929 to Blum. This WIG vessel, like most airplane based WIG vessels, has wings with a relatively short mean chord length. It is recognized by IMO, that the ground effect phenomenon generally occurs at an altitude of less than the mean chord length of the wing. Thus, one of the disadvantages of such WIG vessels is that they are only capable of flight at very low altitude, generally 1-5 meters, where they risk colliding with waves during cruise. The low altitude over water restricts their operations to inland waters such as rivers or lakes with no or minimal waves.

Airplane-based WIG vessels generally have wings consisting of a structure with curved surfaces, referred to as an airfoil, designed to give the most favorable ratio of lift to drag in flight. These WIG vessels produce aerodynamic lift through air flowing over the airfoil, with the lift produced from the upper or top side of the wing and referred to as the Bernoulli effect. Airplane-based WIG vessels fly in ground effect with a combination of aerodynamic lift from the airfoil and a cushion of high-pressure air between the wings and the surface, resulting in increased lift by the wing.

There are many complex reasons why airplane-based WIG vessels don't simply increase the mean chord length to achieve more altitude in ground effect. A wing in ground effect is affected by numerous factors such as drag, both induced and parasitic, wingspan, mean chord length, angle of attack, wing loading (WIG vessel weight per unit-area of the wing) as well as the weight, speed and configuration of the WIG vessel. All these factors are interrelated. For example, if the mean chord length of an airplane-based WIG vessel is drastically increased, the wing will be correspondingly thick and structurally heavy in order to maintain the necessary airfoil shape. In turn, a heavier wing requires an even larger wing to reduce the wing loading that has a direct relationship to the speed necessary for take-off and directly relates to the next problem described below.

Another problem with traditional airplane-based WIG vessels is that they, at rest, support their entire weight in the water, and to reach the transition point from waterborne or boat mode to airborne or flight mode, the WIG vessel has to gain considerable speed and overcome the high hydrodynamic drag in order to lift its entire weight out of the water. This requires propulsive thrust that can be many times what is required for actual flight in ground effect. Consequently, WIG vessels need to carry oversized engines, usually meaning heavier, more expensive engines with higher fuel consumption.

Previous art has devised a variety of methods designed to reduce hydrodynamic drag. An example is U.S. Pat. No. 5,267,626 to T. W. Tanfield, Jr. that teaches a method of providing the initial lift by diverting thrust airflow from the propulsion gas exit to the forward area of an enclosed hull lift area. Another example is U.S. Pat. No. 3,931,942 to Alpert that teaches an aerodynamically shaped multi-function aircraft utilizing a series of short cord airfoils positioned below the fuselage and a combination of pivoting forward and rear air walls to provide the needed air cushion for ground effect activities. When air is blown into the plenum chamber it produces a cushion of air between the fuselage and the ground/water that lifts the vehicle a few inches to about a foot off the ground or water.

None of the methods designed to reduce hydrodynamic drag provide satisfactory solutions as they are, at best, useful on calm waters with minimal or no waves.

A further problem with current art is that before achieving lift-off from the water an airplane-based WIG vessel needs to reach a relatively high speed. The impact forces at such speeds, even from small waves, are extremely large and WIG vessels are therefore generally unable to take off or land in rough sea.

Yet another difficulty experienced by airplane based WIG vessels is that, at their low flying altitudes, they cannot bank at large angles to generate the turning force, as that would cause the tip of the wing to dig in to the water and the WIG vessel to overturn. These WIG vessels therefore have extremely large turning radii, making them difficult to maneuver in narrow waters or where there is dense boat traffic.

In light of the foregoing, it would be advantageous to have a WIG vessel that can achieve more altitude above the water as well as the ability to perform STOL (short take-offs and landings) in most sea states.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. In certain embodiments, the disclosed embodiments may include one or more of the features described herein.

In accordance to an embodiment of the invention, a novel WIG vessel is provided.

A new WIG vessel falls into category type A or B of the IMO Interim Guidelines for WIG vessels and can achieve considerably more altitude above the water than all known airplane-based WIG vessels in the same category. In addition, it can perform STOL in most sea states.

In accordance with one embodiment of the present invention, there is provided a WIG vessel that includes a hull with wings attached. The wings have an extremely long chord length, longer than the wingspan, and a very low wing loading. The hull has interior gas-holding envelopes containing a lighter-than-air gas. A propulsion system as well as fins and rudders are mounted on the hull. The hull has a compartment for crew.

A new WIG vessel includes a hull, lighter-than-air gas within the hull, a propulsion system attached to the hull, and a plurality of wings attached to the hull having a mean chord length of 14 meters or more. The hull, propulsion system and wings are configured for traveling on water and for traveling in the air in ground effect. In an embodiment, the wings have a mean chord length to mean span ratio less than or equal to one. The hull may include a fore conical end portion. The wings may be of uniform thickness.

In an embodiment one or more gas holding envelopes inside the hull hold the lighter-than-air gas. In an embodiment, the wings are anhedral or a combination of anhedral and dihedral. The wings may include endplates. In an embodiment, an impeller device or blower is configured to create an internal pressure in the hull higher than the ambient atmospheric pressure, in order to maintain the shape and rigidity of the hull. The hull may require no internal structure or bracing to maintain its shape.

In an embodiment, a weight transfer system is included for transferring weight between the fore and aft of the vessel in order to adjust its pitch. The weight transfer system may include a plurality of ballast containers inside the hull where at least one of the ballast containers is located further to the fore of the hull and one further to the aft and the containers are connected and configured for transfer of ballast between the containers in order to change the pitch of the WIG vessel during operation in flight mode.

In an embodiment, the vessel includes a canard-like wing, elevator or vane having a rear end configured for downward rotation from a neutral or horizontal position, where downward rotation of the rear end from a neutral or horizontal position causes the fore of the hull to pitch upwards. In an embodiment, the vessel includes propulsion units and horizontal flaps mounted rear of the propulsion units configured for downward rotation from a neutral horizontal position. The flaps when rotated downwards from the neutral horizontal position deflect thrust from the propulsion units and force the front of the WIG vessel upward.

In an embodiment, the hull includes a fore conical end portion, an aft conical end portion, and a generally cylindrical intermediate portion extending between the fore and aft conical end portions. The propulsion system may be mounted at a fore apex of the fore conical end portion. In an embodiment, the propulsion system includes a mounting framework secured to a conical aft end of the hull and a propulsion unit connected to the mounting framework. The mounting framework includes two or more circular-shaped frame portions of decreasing diameter and frame members extending between and connecting the frame portions, creating an open-ended cone of a size such that when the frame portion of greatest diameter is placed over and coincides with the diameter of the conical aft end of the hull, the frame portion of least diameter is located near the aft apex of the hull and each of the frame members is touching the hull. The mounting framework may be bowed or curved to closely correspond to the radius of curvature of the hull.

In an embodiment, the propulsion system comprises a propulsion unit and a propulsion mounting framework, wherein the mounting framework has an outer, square-shaped frame portion, an inner, cross-shaped, frame portion attached to the outer frame portion, and a cantilevered pod or outrigger fastened to the cross-shaped frame portion, wherein the propulsion unit is attached to the cantilevered pod or outrigger.

In an embodiment, flexible sleeves attached to the hull at their middle and having hook-and-look fasteners on their ends fasten the wings or propulsion system to the hull by wrapping around frame members. In an embodiment, a divider or bulkhead inside and attached to the hull is configured to section off the foremost portion of the hull into a bridge. There may also be an open-ended cone attached to the inside of the hull, shaped to conform to the interior shape of the hull, and forming the perimeter of the bridge, including rings connected by a plurality of tubular frame members. The bridge may also include a floor secured to the open-ended cone, a seat, an access hatch, and instruments and sensors. There may also be a passenger compartment having a deck or floor, a ceiling, and windows and a passageway extending between the passenger compartment and the bridge.

In an embodiment, a second hull is connected to the hull and one of the lifting surfaces extends between the hulls. In an embodiment, the wings have a wing loading of 1.5 kg/m² or less.

A new WIG vessel for traveling on water and in the air has, in combination, a hull containing lighter-than-air gas, wings and means for propulsion. The wings may have a chord length equal to or longer than the wingspan, the wings may be of uniform thickness, and the means for propulsion may include diesel engines.

In a new method of operating a WIG vessel, the pitch of the vessel is changed by means of weight transfer.

A WIG vessel for traveling on water and in the air includes a watertight inflatable hull of substantial size made of a semi-rigid material, a plurality of wings with a mean chord length about equal to or larger than the wingspan, a propulsion system, and a plurality of gas holding envelopes. The hull may be made of a rigid material and the wings may be anhedral. The WIG vessel may also include means for changing the pitch of the WIG vessel.

A new WIG vessel for traveling on water and in the air includes a watertight inflatable hull of substantial size made of a semi-rigid material and shaped as a product.

These and further and other objects and features of the invention are apparent in the disclosure, which includes the above and ongoing written specification, with the drawings.

### BRIEF DESCRIPTION OF THE DRAWINGS

The embodiments of the present invention shall be more clearly understood with reference to the following detailed description taken in conjunction with the accompanying drawings, in which:

FIG. 1 is a perspective view of one embodiment of a WIG vessel of the present invention;

FIG. 2 is a top plan view of the WIG vessel shown in FIG. 1;

FIG. 3 is a side elevation view of the WIG vessel illustrated in FIG. 1;

FIG. 4 is a cross-sectional view of the WIG vessel illustrated in FIG. 3, taken along the cross-section line “4-4”;

FIGS. 5a, 5b, 5c and 5d are all cross-sectional views illustrating alternative wing configurations for WIG vessels of the present invention;

FIG. 6 is a partial side view of the aft section of the WIG vessel shown in FIG. 1;

FIG. 7 is a perspective view of the mounting framework shown in FIG. 6;

FIG. 8 is a partial side view of the fore section of a WIG vessel with an alternate device for changing the pitch of the WIG vessel;

FIG. 9 is a partial top plan view of the WIG vessel and device shown in FIG. 8;

FIG. 10 is a top plan view of a WIG vessel with yet another alternate device for changing the pitch of the WIG vessel;

FIG. 11 is a side view of the WIG vessel and device shown in FIG. 10;

FIG. 12 is a perspective view of a WIG vessel with alternate propulsion units;

FIG. 13 is a top plan view of the WIG vessel shown in FIG. 12;

FIG. 14 is a perspective view of a framework for the alternate propulsion units shown in FIGS. 12 and 13;

FIG. 15 is a side elevation of the WIG vessel shown in FIG. 1 but without wings and propulsion unit for clarity;

FIG. 16 is an enlarged side elevation view of the fore section of the WIG vessel illustrated in FIG. 15;

FIG. 17 is a perspective view of the open-ended cone shown in FIG. 16;

FIGS. 18a and 18b are detailed views of the sleeves;

FIG. 19 is an enlarged side elevation view similar to FIG. 16, with some tubular frame members removed for clarity;

FIG. 20 is a frontal view of FIG. 19;

FIG. 21 is a side view showing partial dividers;

FIG. 22 is a side view showing gas-holding envelopes;

FIG. 23 is a perspective view of an alternative embodiment—a passenger carrying WIG vessel;

FIG. 24 is a side view of an alternative embodiment—a sneaker shaped WIG vessel;

FIG. 25 is a top plan view of the WIG vessel in FIG. 24;

FIG. 26 is a perspective view of an alternative embodiment—a bottle shaped WIG vessel;

FIG. 27 is a rear view of the WIG vessel in FIG. 26;

FIG. 28 is a top plan view of an alternative embodiment—a catamaran WIG vessel;

FIG. 29 is a rear view of the WIG vessel in FIG. 28;

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### LIST OF REFERENCE NUMERALS

The following table provides a list of reference numerals for components in the detailed description.

| L_{H} | total length - hull |
|---|---|
| D_{H} | maximum diameter - hull |
| L_{C} | Mean chord length |
| W_{S} | Wingspan |
| H_{W} | Distance between wing root and bottom of hull |
| 100 | WIG vessel |
| 102 | Hull |
| 104 | Fore conical end portion |
| 106 | Aft conical end portion |
| 108 | Cylindrical intermediate portion |
| 110 | First margin |
| 112 | Second margin |
| 114 | Fore apex |
| 116 | Aft apex |
| 118 | Propulsion unit |
| 120 | Fin |
| 121 | Wires |
| 122 | Rudder |
| 124 | Bridge |
| 126 | Wing |
| 128 | Leading edge |
| 130 | Trailing edge |
| 132 | Strut |
| 134 | Blower |
| 136 | Ballast container |
| 138 | APU |
| 140 | Mounting framework - propulsion |
| 142 | Frame portion |
| 144 | Second frame portion |
| 146a, b, c, d | Frame members |
| 148 | Bulkhead - bridge |
| 150a, b, c, d | Rings |
| 152 | Frame members |
| 154 | Open-ended cone |
| 156 | Trusses |
| 158 | Floor |
| 160 | Seat |
| 162 | Dome |
| 164 | Access hatch |
| 166 | Tubular ring |
| 168 | Gas struts |
| 170 | Ladder |
| 171 | Partial dividers |
| 172a, b, c, d | Compartments |
| 173 | Gas holding envelopes |
| 180 | Sleeves |
| 181 | Fabric |
| 182 | Exemplary frame member - tube |
| 183a, b | Width - fabric |
| 184 | Hook Velcro ® |
| 186 | Loop Velcro ® |
| 188 | Fastened - sewn |

ALTERNATIVE EMBODIMENTS

| | |
|---|---|
| 201 | Wing |
| 202 | Endplates |
| 300 | WIG vessel |
| 302 | Vane |
| 304 | Fore conical end portion |
| 306 | Fore apex |
| 400 | WIG vessel |
| 402 | Hull |
| 404 | Propulsion units |
| 406 | First margin |
| 408 | Propellers |
| 410 | Horizontal flaps |
| 412 | Fore apex |
| 414 | Aft apex |
| 500 | WIG vessel |
| 502 | Hull |
| 504 | Propulsion unit |
| 506 | ″ |
| 508 | ″ |
| 510 | ″ |
| 512 | Framework |
| 514 | Square-shaped, frame portion |
| 516 | Cross-shaped, frame portion |
| 518 | Outrigger |
| 600 | WIG vessel - passenger carrying |
| 602 | Hull |
| 604 | Passenger compartment |
| 606 | Floor |
| 608 | Ceiling |
| 610 | Window |
| 612 | Bridge |
| 614 | Passageway |
| 616 | Stairs |
| 618 | Wing |
| 700 | WIG vessel - sneaker |
| 702 | Hull |
| 704 | Propulsion units |
| 706 | Wing |
| 708 | Bridge |
| 800 | WIG vessel - bottle |
| 802 | Hull |
| 804 | Wing |
| 806 | Propulsion unit |
| 808 | Bridge |
| 900 | WIG vessel - catamaran |
| 902 | Hull |
| 904 | Wing |
| 906 | Middle wing |
| 908 | Structure |

### DETAILED DESCRIPTION

A new WIG vessel will now be disclosed in terms of various exemplary embodiments. This specification discloses one or more embodiments that incorporate features of the invention. The embodiment(s) described, and references in the specification to “some embodiments”, “one embodiment”, “an embodiment”, “an example embodiment”, etc., indicate that the embodiment(s) described may include a particular feature, structure, or characteristic. Such phrases are not necessarily referring to the same embodiment(s). When a particular feature, structure, or characteristic is described in connection with an embodiment, persons skilled in the art may effect such feature, structure, or characteristic in connection with other embodiments whether or not explicitly described.

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

Embodiments of the present invention will now be described with reference to the attached figures. Various structures, connections, systems and devices are schematically depicted in the drawings for purposes of explanation only and so as to not obscure the disclosed subject matter with details that are well known to those skilled in the art. Nevertheless, the attached drawings are included to describe and explain illustrative examples of the present invention.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Reference numerals in the one hundreds (100-199) are used to identify parts or features of one embodiment being described in the detailed description. It is to be understood that when alternative embodiments are described, numerals in the one hundreds will occasionally be used to indicate that the part or feature in the alternative embodiment has a similar or the same function or feature as the original part or feature associated with that numeral.

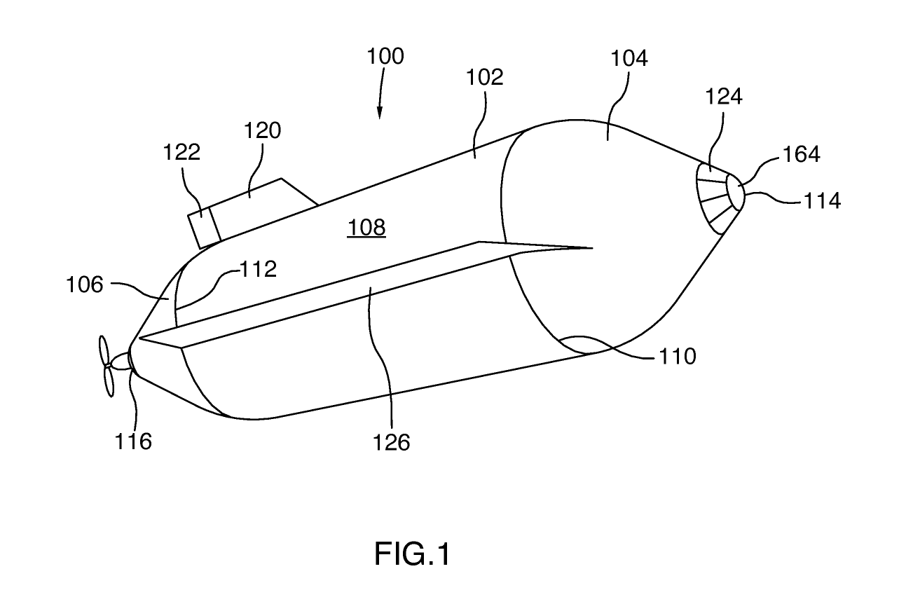

FIG. 1 is a perspective view of one embodiment of a WIG vessel of the present invention, designated generally with reference numeral 100. The WIG vessel 100 includes a hull 102 having a generally elongated shape defined by a fore conical end portion 104, an aft conical end portion 106 and a generally cylindrical intermediate portion 108 extending between the fore and aft conical end portions 104 and 106. The intermediate portion 108 meets the fore conical end portion 104 along a first margin 110 and the aft conical end portion 106 along a second margin 112. Conical end portion 104 extends outwardly and away from margin 110 in a tapering fashion to ultimately terminate in the fore apex 114. Conical end portion 106 extends outwardly and away from margin 112 in a tapering fashion to ultimately terminate in the aft apex 116.

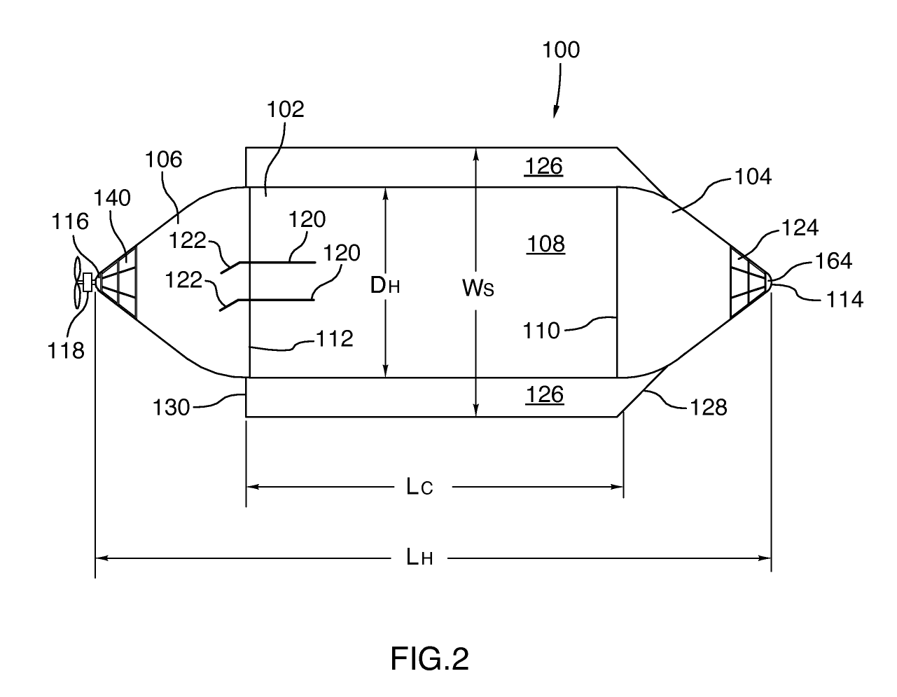

As shown in FIG. 2, a top plan view, the hull 102 has a total length L_{H} that corresponds to the distance between the apexes 114 and 116 and a maximum diameter D_{H} which corresponds to the diameter of the intermediate portion 108. In this embodiment, the length L_{H} measures 52 meters; the diameter D_{H} measures 14.6 meters.

In alternative embodiments, the hull 102 could be sized differently. For instance, the dimensions L_{H} and D_{H} could be increased or decreased. In still other embodiments, the hull 102 could be formed with a different shape altogether.

In this embodiment, the hull 102 is manufactured from an air and water-tight material that is formed from panels that are joined together by sewing, with the stitching sealed with a silicone sealant so as to be air and water impermeable.

As an alternative, the panels may be joined together by heat welding, adhesives, or any other joining techniques known to those skilled in the art.

The hull 102 in this embodiment is manufactured from a fabric made of Spectra® fibers, a Honeywell International Inc. product, which are woven into fabric and laminated with a Tedlar® film, a DuPont product, to provide the air and water impermeability required.

In other embodiments the hull 102 can be manufactured from composite fabrics, for example with carbon fibers or filament fiberglass. Rigid or semi-rigid materials such as fiberglass, sheet metal or any other strong, relatively light weight materials that are air and water impermeable can also be used for the hull 102. In yet other embodiments the hull 102 can be manufactured from a combination of several materials, for example, the upper part made from Spectra® fabric with a bottom part made from fiberglass or aluminum.

In yet another embodiment the hull 102 could be made from fabric and have an internal structural framework to retain its shape.

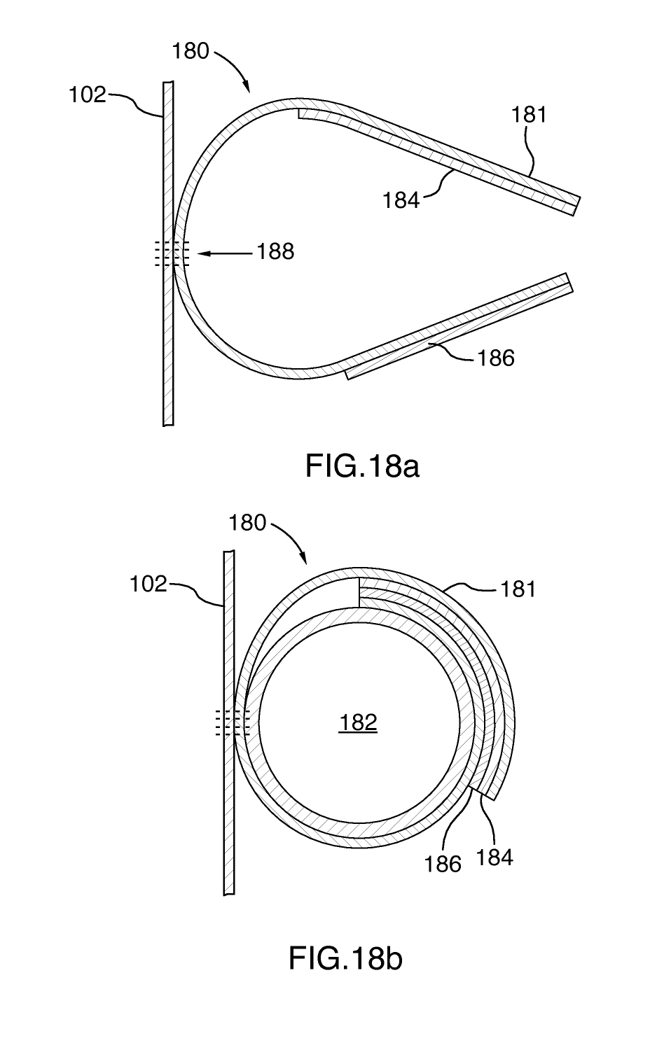

One method used to attach various parts to the hull 102 is with lightweight flexible sleeves 180, an embodiment of which now will be described in detail and shown in FIGS. 18a and 18b.

The sleeves 180 consist of fabric or other flexible material 181 of a suitable size to fit the length of the exemplary frame member 182. The width as measured from 183a to 183b of the fabric 181 should be about 150% of the circumference of the exemplary frame member 182. Hook Velcro® 184 is sewn to the inside free end, that terminates in 183a, of the fabric 181 as illustrated in FIG. 18a. Loop Velcro® 186 is similarly sewn to the outside of the free end, that terminates in 183b, of the fabric 181. The sleeve 180 is fastened 188, by sewing, to the hull 102, although in alternative embodiments other fastening methods are utilized. When the exemplary frame member 182 is positioned in the sleeve 180 the loop Velcro® 186 end, terminating in 183b, is wrapped around the exemplary frame member 182 followed by wrapping the hook Velcro® 184 end, terminating in 183a, over and on top of loop Velcro® 186 so that the hook Velcro® 184 and loop Velcro® 186 may lock together as illustrated in FIG. 18b, thereby securing the exemplary frame member 182 to the hull 102.

While the use of sleeves 180 is one method of fastening various parts to the hull 102, it should be appreciated that this need not be the case in every application. For example, straps or webbings could be used to attach parts to the hull 102. In a further alternative, various parts could be attached to an internal frame of the hull 102. A hull made from rigid or semi rigid material would require other suitable means of fastening parts to the hull.

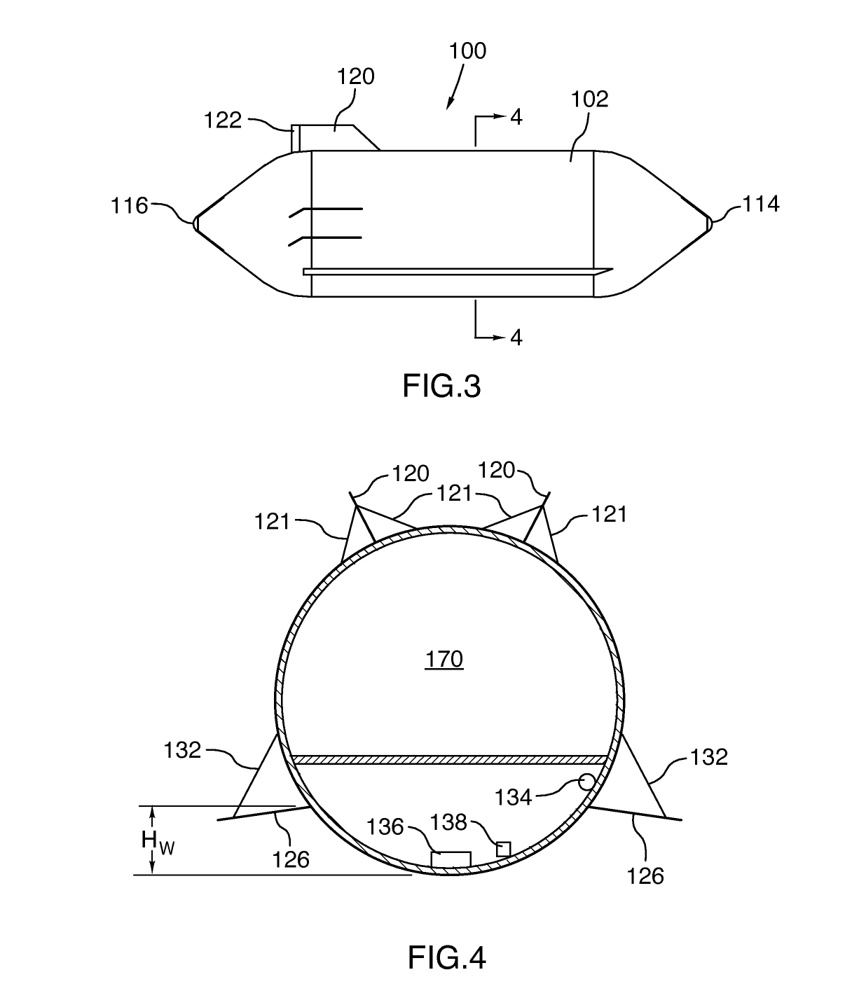

As best shown in FIGS. 2, 3 and 4, the WIG vessel 100 embodiment also has fins or stabilizers 120 securely attached to the hull 102. Pivoting rudders 122 are hinged at the trailing end of the fins 120. The rudders 122 are activated by electric linear actuators (not shown). In other embodiments the rudders 122 can be activated by push/pull cables, hydraulic or electric, linear or rotational actuators or other suitable means known in the arts.

Both the fins 120 and rudders 122 are made in a conventional way, well known in the art, with ribs and spars covered with fabric. In other embodiments the stabilizers and rudders could be made from composites, aluminum or other suitable materials. In yet other embodiments the fins could be structural inflatables.

The fins 120 are attached to hull 102 using a plurality of sleeves 180, not shown but previously described, and further secured by bracing the fins 120 with wires 121 to the hull 102,

In alternative embodiments, the hull 102 could have a lesser or greater number of fins, with or without rudders. The fins could be laced to the hull or attached with any other suitable method known in the arts.

The fins 120 provide directional stability for WIG vessel 100 and the rudders 122 provides steering or directional control. However, in alternative embodiments the WIG vessel could be without fins and directional stability as well as steering or directional control could be accomplished with vectored or differential thrust from propulsion units, such as disclosed in U.S. Pat. No. 5,294,076 by the same inventor and assignee as the present invention, which is incorporated herein by reference.

As best shown in FIGS. 2 and 4, two lifting surfaces or wings 126, one on the starboard side and one on the port side, are fixedly mounted to the hull 102, and are further secured and supported by struts 132. Although the wings of the WIG vessels of the current invention may be of an airfoil shape, the wings 126 in the embodiment shown are not airfoil shaped but of uniform thickness. The lifting force for such wings during forward motion is created entirely under the wings, when angled in an upward position at their leading edges (also referred to as a positive angle of attack), creating a cushion of higher density air between the wings and the surface below. Foregoing the aerodynamic lift created by airfoil-shaped wings is compensated for in some such embodiments by extremely low wing loading, generally below 1.5 kg/m². As a comparison, the wing loading for a Cessna 182, a four-seat, single-engine, fixed-wing aircraft is 87 kg/m². The extremely low wing loading is achieved by partial aerostatic lift.

The wings 126 extend between a leading edge 128 and a trailing edge 130. The wings 126 in the embodiment shown have a mean chord L_{c} of twenty-nine and a half meters and as it is recognized that the ground effect phenomenon generally occurs at an altitude of less than the mean chord length of the wings, WIG vessel 100 may therefore be capable of altitudes of about 20 meters. The WMO (World Meteorological Organization) Sea State Code defines wave heights of 4 to 6 meters as very rough; wave heights of 6 to 9 meters as high; wave heights of 9 to 14 meters as very high and wave heights over 14 meters as phenomenal. It can therefore be assumed that at about 20 meters of altitude the risk of colliding with waves during cruise is minimized. The wingspan W_{S} as shown measures twenty-one meters, giving the wings an extremely low aspect ratio of less than one. A wingspan is the distance from one wing tip to the other wing tip and consequently includes the hull between the wings. The shape of the hull 102 and the wings 126 interact. When moving forward through the air, a portion of the airflow which is accelerated over the fore conical end portion 104 of the hull 102 creates an air cushion under the wings, providing the wing in ground effect. The wings 126 are mounted on hull 102, about three meters (H_{W}) above the lowest part of hull 102 as illustrated in FIG. 4. The wings 126 are attached to hull 102 using a plurality of sleeves 180, not shown but previously described, and further secured and supported by struts 132. One end of the struts 132 is attached to the wings 126 by nuts and bolts and the other end of the struts 132 is attached to the hull 102 using a plurality of sleeves 180. The wings 126 are made in a conventional way, well known in the art, with ribs and spars covered with fabric. In other embodiments the wings can be made from composites, aluminum or other suitable materials. In yet other embodiments the wings could be structural inflatables. In alternative embodiments other methods of fastening the wings and struts to the hull and to each other can be utilized.

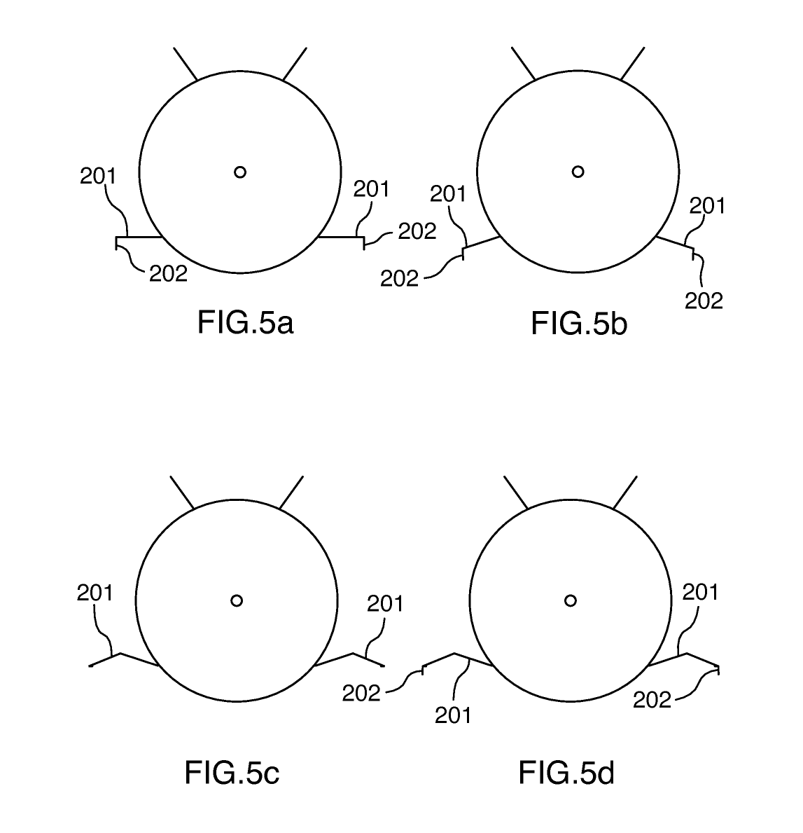

When fastened to WIG vessel 100, the wings 126 are anhedral, having a down angle from horizontal. In other embodiments, as illustrated in FIG. 5, alternative wings 201 could be horizontal and include endplates 202; anhedral with endplates 202 as illustrated in FIG. 5b; a combination of dihedral and anhedral as illustrated in FIG. 5c; or a combination of dihedral and anhedral with endplates 202 as illustrated in FIG. 5d. The wings 126, as illustrated, are generally designed in such a way that during forward motion through the air they create and maintain a cushion of slightly compressed air between the surface and WIG vessel 100. Considerations such as hull shape and size, required speed and lifting capacity determine the type and shape of the wings.

In other embodiments the wings 126 could be sized differently. For instance, the dimensions L_{C} and W_{S} could be increased or decreased. In many embodiments, the aspect ratio of the wings is less than 1. A low aspect ratio allows for a long chord length while minimizing overall wing size and weight and therefore manufacturing cost and complexity, risk of structural failure, and necessary take-off power (and therefore propulsion system size/expense, etc.). A low aspect ratio is possible because substantial aerodynamic lift, and therefore airfoil-shaped wings, are not needed, due to the combination of ground effect and partial aerostatic lift.

The WIG vessel 100 shown includes an impeller device or blower 134 to create an internal pressure in hull 102, that is higher than the ambient atmospheric pressure, in order to maintain the shape and rigidity of the hull 102 and thereby eliminating the need for an internal structure or bracing. To keep the hull 102 in a preferred tension state the internal pressure would typically be 2.5-5 centimeter of H₂O

The blower 134, best seen in FIGS. 4 and 22, is attached to the hull 102 with the inlet through the hull 102 and the outlet inside the hull 102 in such a way that the blower 134 draws ambient air from the outside and exhausts the air to the interior of hull 102.

An airlock (not shown) is provided to allow the introduction of components into the hull 102. Pressurization means and airlocks are well known in the art of air-supported domes or other inflatable structures and therefore need no further description.

In other embodiments, where the hull has an internal structure to retain its shape or is manufactured from a rigid material, the blower could be redundant.

Although the electric power necessary for WIG vessel 100 is generally provided by a generator or alternator (not shown), attached to and powered by the propulsion unit 118, WIG vessel 100 may also include a generator or APU (Auxiliary Power Unit) 138. As can be seen in FIGS. 4 and 22, the APU 138 is located inside hull 102, mounted on a platform or stand (not shown). The APU 138 has a through-the-hull inlet (not shown) that provides air for the combustion engine powering the APU 138. Likewise there is a similar through-the-hull outlet (not shown) for the exhausts from the APU 138.

As best seen in FIGS. 4 and 22, WIG vessel 100 as shown has two ballast containers 136 located inside and generally at the bottom of hull 102, one located near the front and the other near the aft of hull 102. The ballast containers 136 are of marine-type rubber bladders and have a capacity of 500 gallons each. The ballast containers 136 are connected by hoses (not shown) to allow pumps (not shown) to transfer ballast or weight, usually water, between containers.

It should be appreciated that in other embodiments the ballast containers 136 could be made of aluminum, fiberglass or any other suitable material. They could have different capacity and there could be a greater or lesser number, located in different positions, internally as well as externally.

The ballast containers 136 have dual functions; one is to weigh down WIG vessel 100 when anchored and the ballast containers 136 are filled to capacity, the other function of the ballast containers 136 is, when only partially filled, to move water, through hoses and pumps, from one ballast container 136 to the other ballast container 136 in order to change the pitch of WIG vessel 100 during operation in flight mode.

Positive pitch is defined as when, from a horizontal attitude, the fore apex 114 of WIG vessel 100 is higher than the aft apex 116.

WIG vessel 100 is generally considered to be at horizontal attitude and neutral pitch when it is at rest on water.

In the most basic embodiment of WIG vessel 100, no ballast containers 136 are needed as the C of G (centre of gravity) could be arranged in such a way that the WIG vessel 100 would have a constant positive pitch when in flight mode.

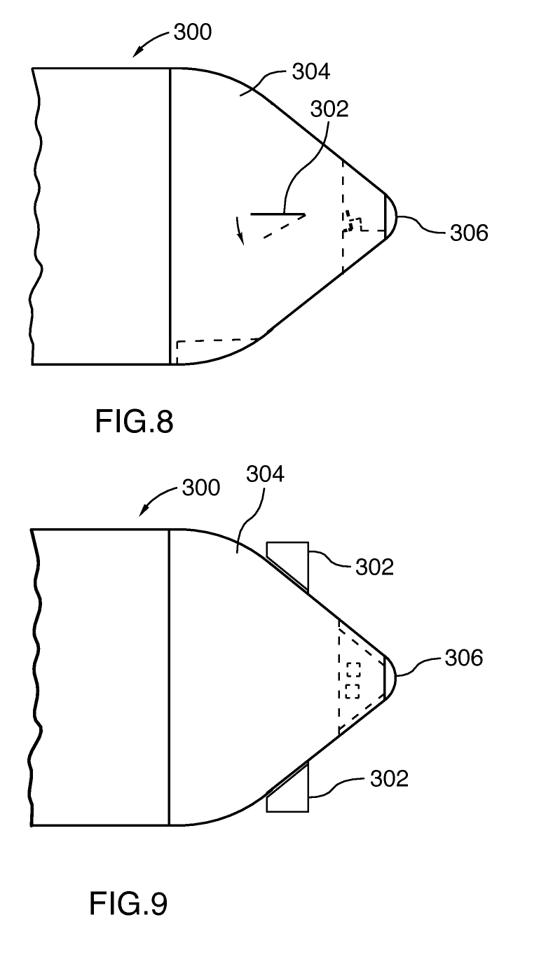

In another embodiment shown as a partial side elevation in FIG. 8 and a partial top plan view in FIG. 9, WIG vessel 300 can achieve a change of pitch with a movable canard-like wing, elevator or vane 302, mounted on the fore conical end portion 304. During sufficient forward speed and when the rear end of the vane 302 is rotated downward from the neutral or horizontal position, the fore apex 306 of WIG vessel 300 will be forced higher than the aft apex (not shown in the drawing). The vane 302 may be rotated by push/pull cables or electric or hydraulic actuators that can be linear or rotational. Any other suitable means known in the arts can be used to rotate vane 302.

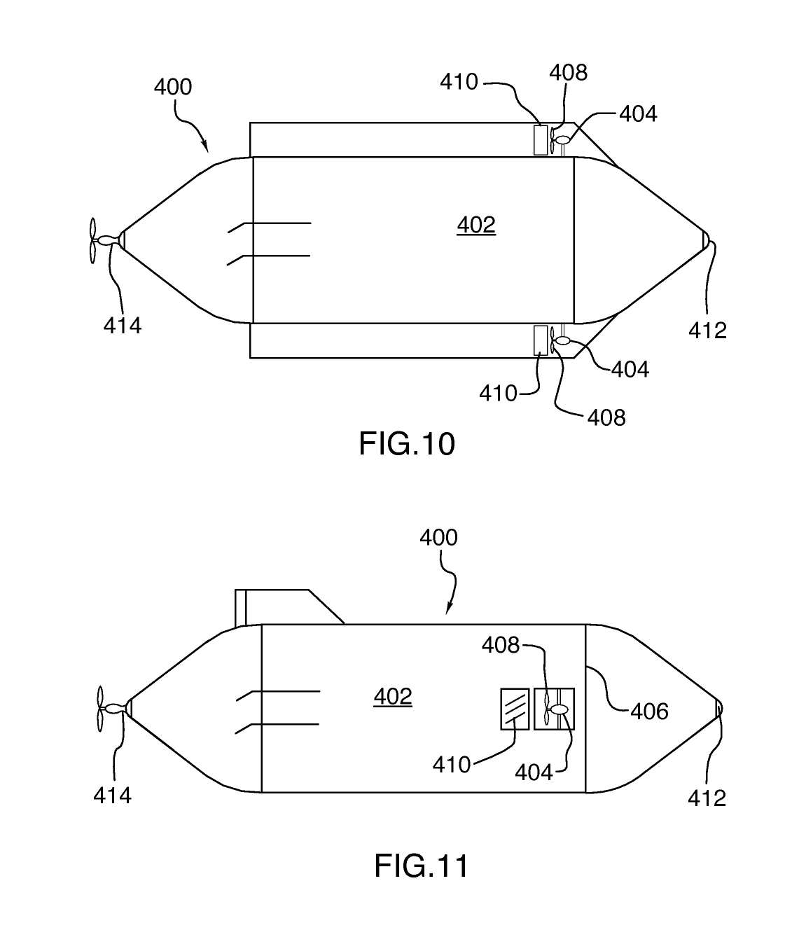

Another embodiment shown in FIGS. 10 and 11 has a pair of propulsion units 404 mounted on generally diametrically opposite sides of hull 402 and close to the first margin 406 of WIG vessel 400. The propulsion units 404 includes pusher type propellers 408. Horizontal flaps 410 mounted rear of the pusher type propellers 408 can be rotated downward from their neutral horizontal position by actuating means and will then deflect thrust from the propellers 408, forcing the fore apex 412 higher than the aft apex 414. This method of deflecting thrust from the propulsion units 404 is described in U.S. Pat. No. 5,294,076 by the same inventor and incorporated herein by reference.

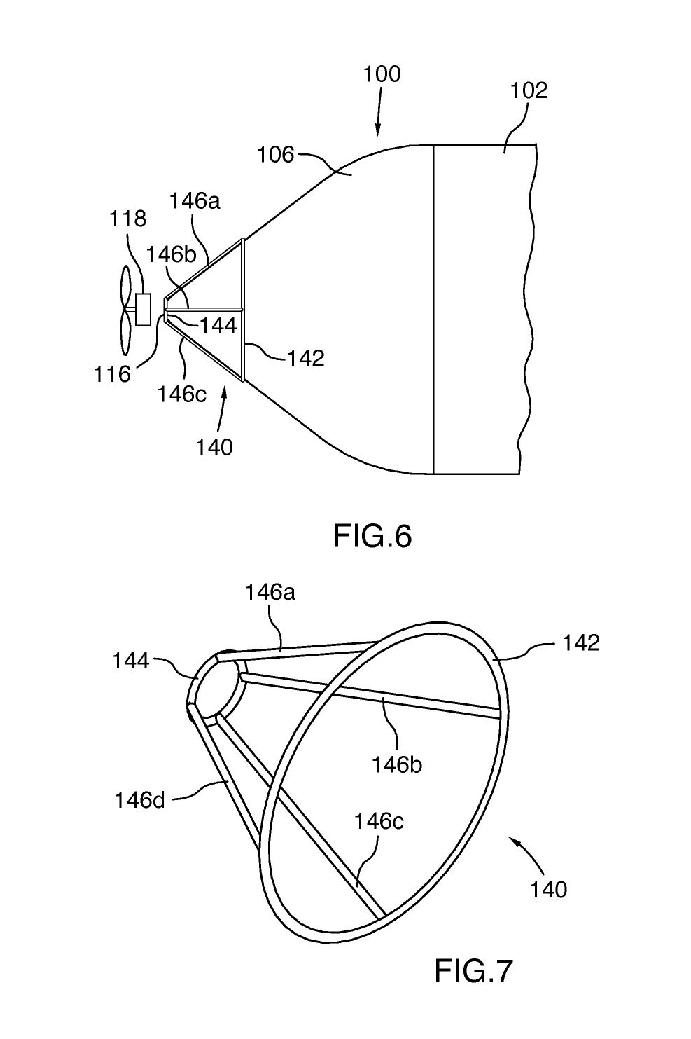

The propulsion system for WIG vessel 100 as shown consists of a mounting framework 140 and propulsion unit 118. As best shown in FIG. 6, a partial view of the aft conical end portion 106 and FIG. 7, a perspective view of the mounting framework 140, the WIG vessel 100 includes a propulsion unit 118, attached to the mounting framework 140 and located at the aft of hull 102.

The mounting framework 140 is defined by a circular-shaped frame portion 142 and a second circular-shaped frame portion 144 with a lesser diameter than frame portion 142. One end of frame members 146a, 146b, 146c and 146d is welded to frame portion 142 and the other end is welded to frame portion 144, creating an open-ended cone as best seen in FIG. 7. The size of the cone is such that when frame portion 142 coincides with the diameter of the aft conical end portion 106, the frame portion 144 is located at the aft apex 116 and each of frame members 146a, 146b, 146c and 146d coincides with the aft conical end portion 106 in order to facilitate attachment of the mounting framework 140 to the hull 102 by encouraging close contact between the frame members 146a, 146b, 146c and 146d as well as frame portion 142 to the hull 102. In this regard, the mounting framework 140 is secured to the hull 102 using a plurality of sleeves 180, as previously described. It will thus be appreciated that as configured the mounting framework 140 provides multiple attachment sites for the sleeves 180 and in this manner tends to distribute the forces acting on the hull 102.

One skilled in the art will recognize that the distance between frame portions 142 and 144 depends on the weight of the propulsion unit 118. A heavier propulsion unit would require a larger distance between frame portions 142 and 144 than a propulsion unit with a relatively lesser weight. The distance between frame portions 142 and 144 will also determine the diameter of frame portion 142.

Both the frame portion 142 and 144 as well as each of the frame members 146a, 146b, 146c and 146d is a tubular structural member made of 4130 Chromoly tubing.

In other embodiments, the mounting framework could be shaped, sized and configured differently and could be manufactured from other suitable materials, for example, from aluminum or composites. Instead of being built up of welded tubular members, it could be constructed of other hollow structural members assembled using fasteners or other suitable assembly techniques. Additionally, while the use of sleeves 180 is the current means of fastening the mounting framework 140 to the hull 102, it should be appreciated that this need not be the case in every application. In other embodiments, the mounting framework could be attached to the hull, with for example, straps or webbings. In a further alternative, the mounting framework could be attached to an internal frame of the hull. A hull made from rigid or semi rigid material would require other suitable means of fastening the mounting framework to the hull.

The propulsion unit 118 in one embodiment includes a 200 h.p. diesel-powered combustion engine operatively connected to a pusher type propeller. The engine is a conventional diesel engine that has been modified to incorporate a propeller speed reduction unit (not shown). The propulsion unit 118 is mounted to the mounting framework 140 through a dynafocal mount (not shown), a method well known in the arts. The propulsion unit 118 could be attached to the mounting framework 140 in any one of the many methods known in the art.

In alternative embodiments, other types of engines could be utilized for the propulsion unit. For instance, gasoline, propane or natural gas powered combustion engines could be employed. Alternatively, turbine engines or electric motors powered by generators or batteries may be used. In a further alternative, fuel cells or a photovoltaic array could generate electric power, stored in batteries and provide power to electric motors.

In yet other embodiments the propeller/s could be of tractor or pulling type.

It should be appreciated that other embodiments could include a greater number of propulsion systems disposed in alternate positions along the hull.

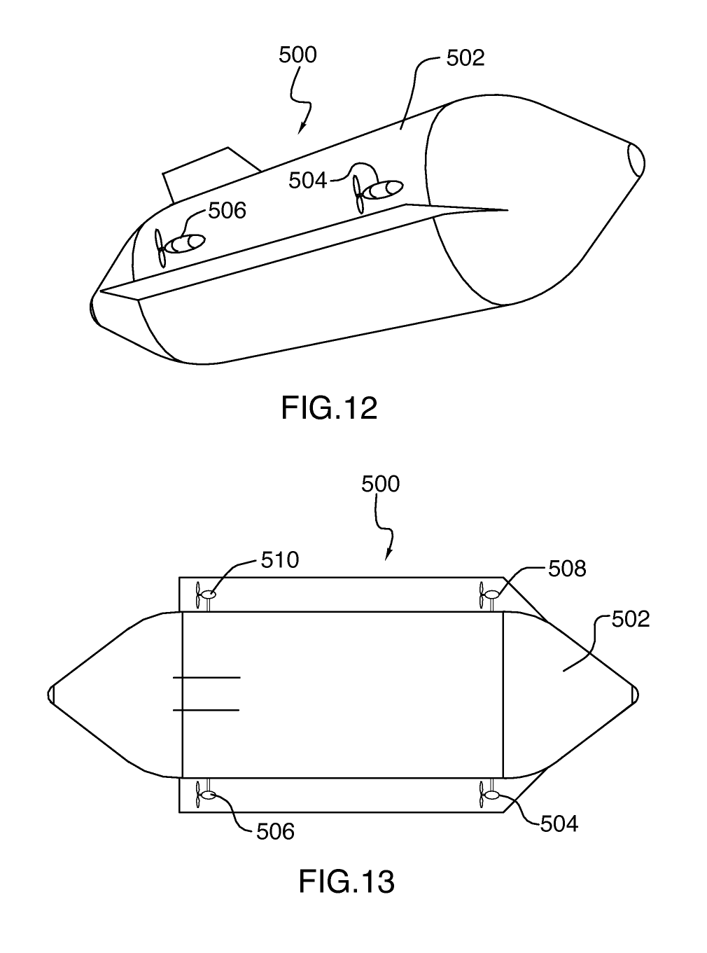

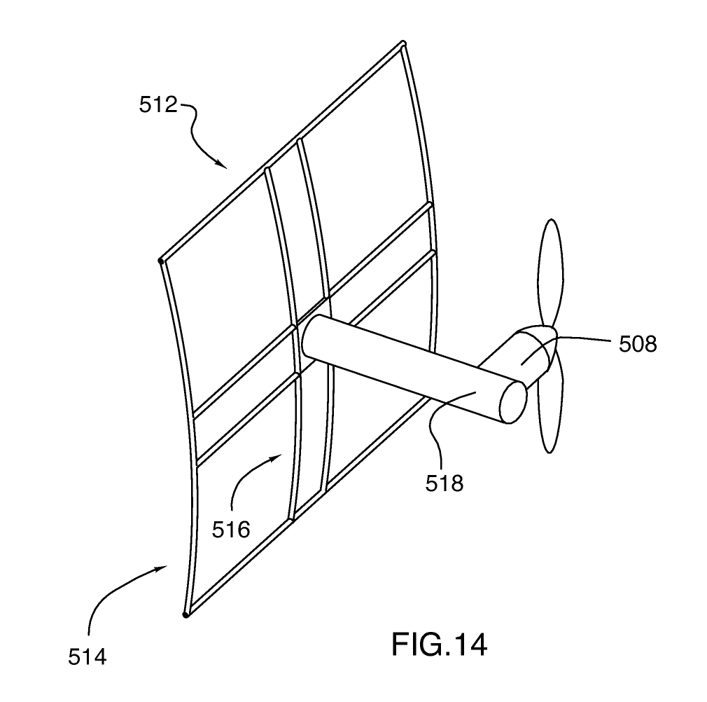

FIG. 12, a perspective view and FIG. 13 a top plan view shows an example of an embodiment with four propulsion units 504, 506, 508 and 510 mounted on hull 502 of WIG vessel 500.

Each of the propulsion units 504, 506, 508 and 510 have the same general structure and are each mounted to a framework 512, shown on FIG. 14, such that the description of one representative assembly—508 and 512—will suffice to enable a person skilled in the art to appreciate the embodiment.

With reference to FIG. 14, the propulsion systems framework 512 and the propulsion unit 508 will now be described in greater detail. The propulsion unit 508 could be a conventional diesel-powered combustion engine. However, gasoline, propane or natural gas powered combustion engines could also be employed as well as turbine engines. Electric motors powered by fuel cells or a photovoltaic array could generate electric power, stored in batteries and provide power to the electric motors. Any engine or motor utilized could be operatively connected to a propeller.

The framework 512 has an outer, square-shaped, frame portion 514 and an inner, cross-shaped, frame portion 516 attached to the outer frame portion 514. A cantilevered pod or outrigger 518 is welded, attached with bolts and nuts or otherwise securely fastened to the cross-shaped, frame portion 516. Propulsion unit 508 is attached to the cantilevered outrigger 518 by a dynafocal mount (not shown) or by any other method known in the art.

In this embodiment, each of the frame members of the framework 512 is a tubular structural member made of aircraft-grade aluminum assembled by welding or gussets and rivets or bolts and nuts or any other method known in the arts.

In other embodiments, the framework could be shaped or sized differently and could be manufactured from other suitable materials, for example, from composites.

The frame members of the framework 512 may be bowed or curved to closely correspond to the radius of curvature of the hull 502. This configuration facilitates attachment of the framework 512 to the hull 502 by encouraging close contact between the tubular members of the framework 512 and the hull 502.

In this regard, the framework 512 may be secured to the hull 502 using a plurality of sleeves 180, as previously described, attached to the hull 502. A plurality of cables (not shown) fixed to the hull 502 could also serve to secure the framework 512 to the hull. It will thus be appreciated that as configured the framework 512 provides multiple attachment sites for the sleeves 180 and in this manner tends to distribute the forces acting on the hull 502.

One of ordinary skill in the art will recognize that the size of the framework 512 would depend on the weight of the propulsion units.

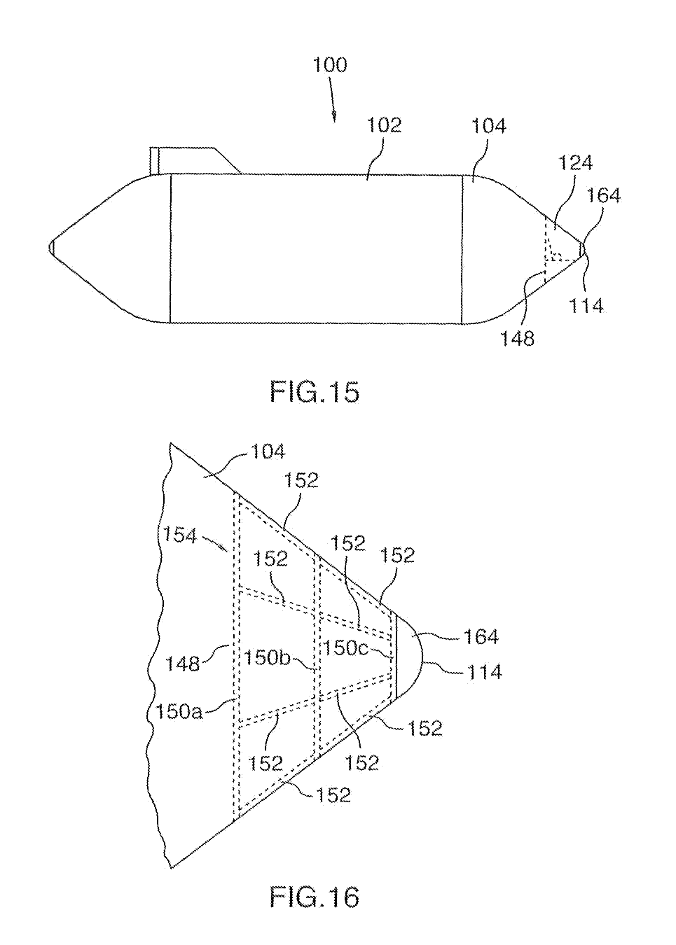

As can be seen in FIG. 15, the WIG vessel 100 shown also includes a bridge or flight deck 124, located inside the fore conical end portion 104 of hull 102.

A divider or bulkhead 148 is used to section off the foremost portion of the fore conical end portion 104. The bulkhead 148 is formed from fabric, attached to the inside surface of hull 102 in such a way that it creates a completely separate space for the bridge 124 in the foremost portion of hull 102.

In other embodiments, the bulkhead 148 can be made from fiberglass, aluminum or other suitable materials and attached to the hull by methods appropriate to the material used.

The location of the bulkhead 148 as measured from the fore apex 114 to the bulkhead 148 is determined by the space required for the bridge 124.

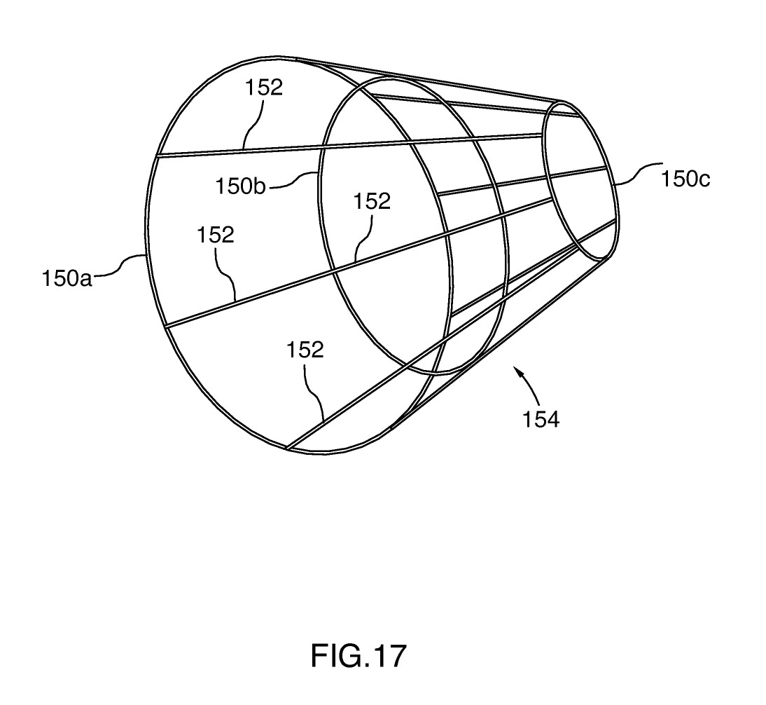

As can be seen in FIG. 16, an enlarged view of the bridge 124 area, three rings 150a, 150b and 150c are connected by a plurality of tubular frame members 152, creating an open-ended cone 154, best seen in FIG. 17, a perspective view of open-ended cone 154, that is shaped to conform to the generally conical interior space created in hull 102, from bulkhead 148 up to, but not including, the access hatch 164.

The open-ended cone 154 is of such size as to fit snugly into the sectioned-off space created inside hull 102, between bulkhead 148 and access hatch 164. This configuration tends to facilitate attachment of the open-ended cone 154 to the hull 102 by encouraging close contact between the open ended cone 154 and the interior of hull 102. In this regard, the open-ended cone 154 is secured to the hull 102 using a plurality of sleeves 180, as previously described, sewn to the hull 102. In alternative embodiments, other methods of attachment are utilized.

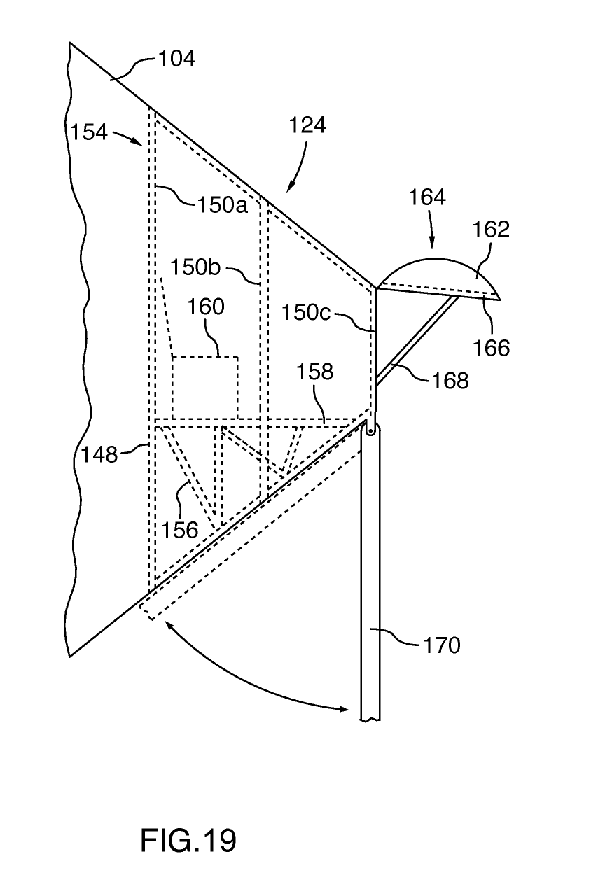

FIG. 19 shows a partial side view of the bridge 124 with some of the tubular frame members 152 removed from the open-ended cone 154 for clarity. Trusses 156 are attached to the open-ended cone 154, providing support for the floor 158 in ways that are well known in the arts. Seat 160 is attached to the floor 158.

The access hatch 164 consist of a dome 162 made from Lexan® and attached to a tubular ring 166, the size of which coincides with the size of ring 150c of the open-ended cone 154. The tubular ring 166 is attached by a suitable hinge (not shown) to the front ring 150c. The access hatch 164 is further supported by gas struts 168.

The open-ended cone 154 and trusses 156 are made of 4130 Chromoly tubing. The floor 158 is made from a laminated honeycomb panel. For ease of installation the open ended cone 154 and the floor 158 can be broken down into segments (not shown) that can be assembled or disassembled.

In other embodiments, the bridge 124 and parts thereof, including the access hatch, could be shaped or sized differently and could be manufactured from other suitable materials, for example, from composites or aluminum.

Portions of the fabric of hull 102 surrounding the bridge 124 is removed and replaced with windows made from Lexan® (or other suitable material) sheets. The opening created by removing a portion of the fabric is covered with a Lexan® sheet that is 5 cm larger on each side than the removed portion. A plurality of bolts and nuts are sandwiching the Lexan® sheet to the fabric of hull 102.

In some embodiments, all instruments, sensors and control functions of WIG vessel 100 are wired or otherwise connected to the bridge 124. The bridge 124 may be used by crew for operating the WIG vessel 100.

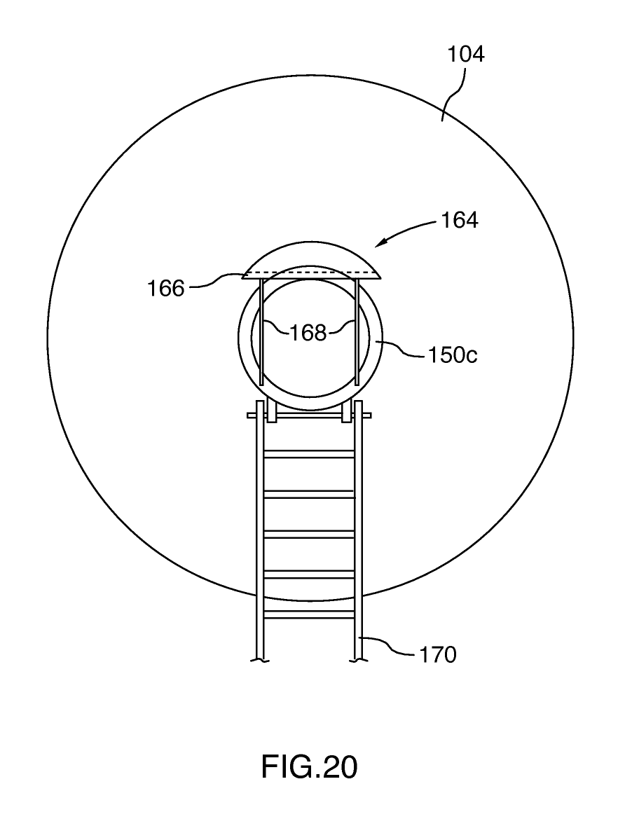

As can be seen in FIGS. 19 and 20, in this embodiment access to the bridge 124 is by a ladder 170, hinged to ring 150c of the open ended cone 154. When not in use the ladder 170 is positioned against the lower portion of the fore conical end portion 104 by rope and pulley (not shown) activated from the bridge 124.

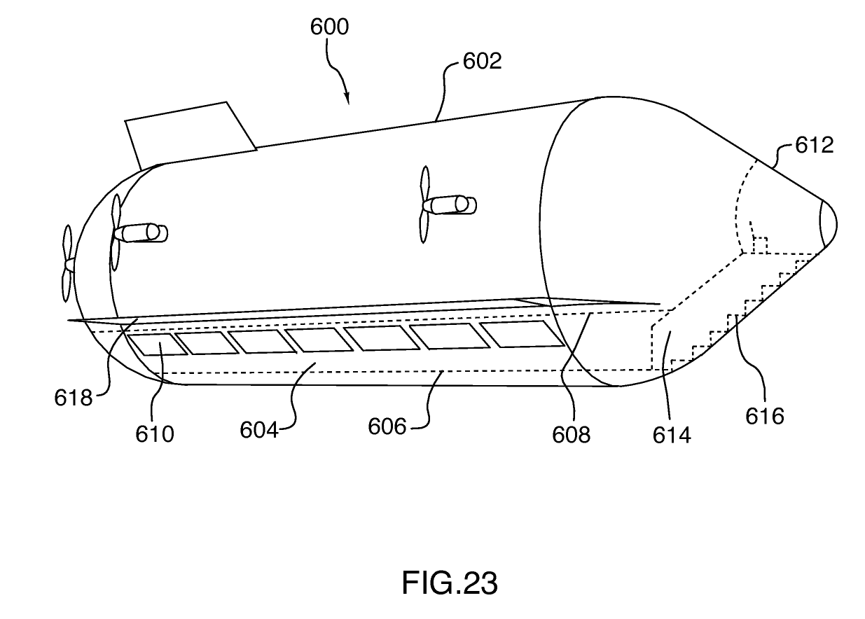

In other embodiments such as described with reference to FIG. 23, a passageway 614 is provided for crew to easily move between the bridge 612 and the passenger compartment 604.

In alternative embodiments, the WIG vessel 100 could be unmanned, remote controlled and/or autonomous and in such case the bridge could be omitted.

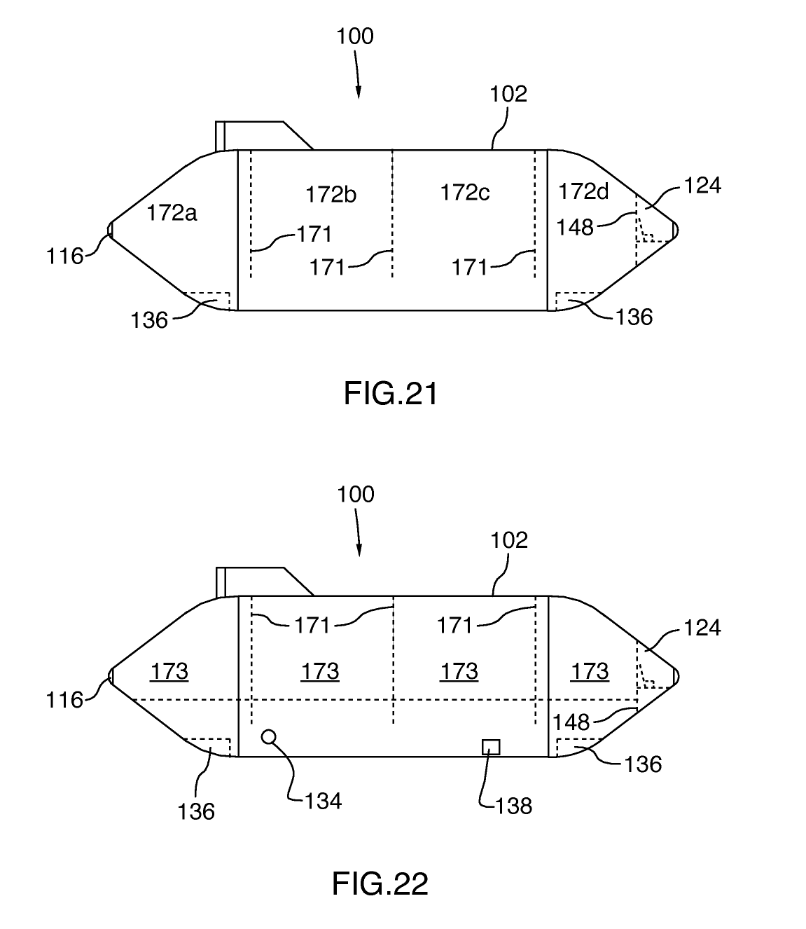

As best seen in FIG. 21, in some embodiments the interior of hull 102 has three partial dividers or bulkheads 171, extending from the top inside surface of hull 102 about 75% of the distance towards the bottom of hull 102.

The partial dividers 171 are formed from fabric sewn to the interior of hull 102, effectively dividing the upper 75% volume of hull 102 into four compartments 172a, 172b, 172c and 172d.

Compartment 172a extends horizontally from a partial divider 171 rearward to aft apex 116. Compartments 172b and 172c extends horizontally between respective partial dividers 171. Compartment 172d extends horizontally from a partial divider 171 forward to bulkhead 148.

In other embodiments, the partial dividers 171 may be formed from other non-rigid material attached or otherwise fastened or suspended to the interior hull 102. In yet other embodiments the partial dividers 171 could be made from fiberglass, aluminum or other suitable materials and attached to the hull by methods appropriate to the material used.

Best seen in FIG. 4 and FIG. 22, in some embodiments gas holding envelopes 173 that are of the same size and shape as each compartment 172a, 172b, 172c and 172d are usually filled to about 90% of their volume capacity with a lighter-than-air gas such as helium, when positioned in respective compartments 172a, 172b, 172c and 172d. When gas holding envelopes 173 are filled at about 90% of their volume capacity with helium they extend downwards from the top inside surface of hull 102 to less than about 75% of the distance towards the bottom of hull 102. When filled with helium, the gas holding envelopes 173 will maintain a relatively fixed position within the hull 102 by friction between the gas holding envelopes 173, the hull 102 and the partial dividers 171.

The gas holding envelopes 173 are manufactured out of thin, gas impervious Mylar® film, a DuPont product.

The gas holding envelopes 173 are formed from panels that are joined together by heat welding so as to be gas impervious

In other embodiments the gas holding envelopes may be manufactured from any other thin, gas impervious material known in the art and joined by adhesives or any other joining techniques known to those skilled in the art.

It will be understood that other embodiments may have a larger or lesser number of partial dividers that may extend a further or lesser distance from the top of the hull. It will also be understood that other embodiments may have a larger or lesser number of gas holding envelopes that may be in other sizes or shapes.

Having described the structure of a representative WIG vessel 100, an exemplary use of the WIG vessel 100 is now described.

In order to describe the operation of WIG vessel 100, it is assumed to be assembled, the gas holding envelopes 173 filled with the appropriate amount of helium, fuel provided for the propulsion unit 118 and in general readied for operation.

The combined volume of helium in the gas holding envelopes 173 provides partial buoyancy or aerostatic lift for WIG vessel 100. When in boat mode and at rest, WIG vessel 100 has a draft of less than 5 cm and is less than 500 kg heavier than neutral buoyancy.

Starting and operating the propulsion unit 118 while also operating the rudders 122 for directional control, WIG vessel 100 is initially moving forward in boat mode.

When water is pumped from the forward ballast container 136 to the rear ballast container 136, WIG vessel 100 will attain a positive pitch while moving forward.

Positive pitch is defined as when, from a horizontal attitude, the fore apex 114 of WIG vessel 100 is higher than the aft apex 116.

WIG vessel 100 is generally considered to be at horizontal attitude and neutral pitch when it is at rest on water.

With increasing speed combined with positive pitch, a cushion of high-pressure air is building up underneath the wings 126 of WIG vessel 100, eventually sufficient for flight in ground effect. The transition from boat mode to flight mode is achieved in a relatively short distance due to the low take-off weight, the size of the wingspan W_{S} and mean chord length L_{C}. The flight envelope is from just above the surface to a maximum cruising altitude that is generally less than the mean chord length L_{C} of the wings 126. As the wings 126 of WIG vessel 100 shown has a mean chord length L_{C} of 29.5 meters, WIG vessel 100 can therefore fly at such altitudes where the risk of colliding with waves is minimal.

Landing WIG vessel 100 and returning to boat mode is achieved by simply reducing the speed and/or reducing the positive pitch until WIG vessel 100 contacts the water.

The WIG vessel 100's combination of low take-off weight of below 500 kg, extremely low draft of less than 5 cm and the large mean chord length L_{C} of 29.5 meters, as well as the very low wing loading of less than 1.5 kg/m², allows WIG vessel 100 to achieve STOL even in rough seas.

### ALTERNATIVE EMBODIMENTS

Alternative embodiments of WIG vessel 100 of the current invention may include cabins or other suitable space, inside or outside the hull 102, to carry passengers, freight or other payload.

FIG. 23 illustrates an embodiment as a passenger carrying WIG vessel 600, with a passenger compartment 604 located inside the lower portion of hull 602. The passenger compartment 604 has a deck or floor 606, a ceiling 608, and windows 610. Crew may operate WIG vessel 600 from the bridge 612 and may enter the bridge 612 from the passenger compartment 604 via a passageway 614, with stairs 616 leading up to the bridge 612.

WIG vessel 600 has wings 618 and is in general an enlarged version of WIG vessel 100, functioning and operated in similar ways. WIG vessel 600 could have a length of 100 meters or even 200 meters or more. WIG vessel 600 could also have seats for passengers, cabins, lavatories, bars and restaurants.

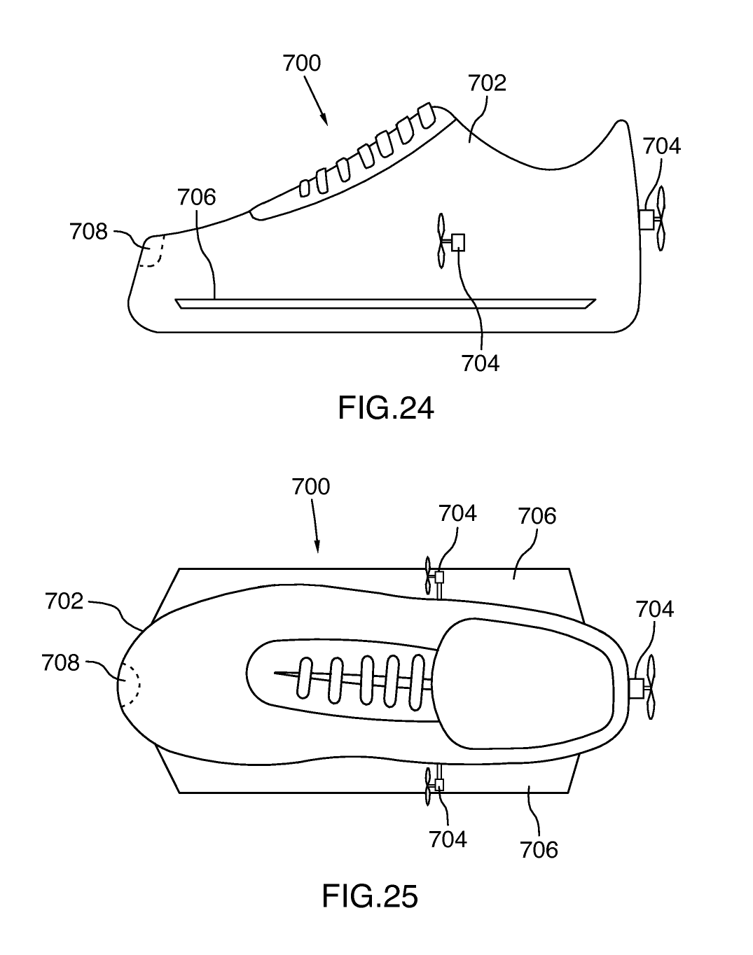

Other embodiments can include product or fantasy-shaped WIG vessels. FIG. 24 is a side view and FIG. 25 is a top plan view of the embodiment of WIG vessel 700, with a hull 702 in the shape of a shoe or sneaker. The hull 702 may have a length of 50 meters or even 100 meters or more. The WIG vessel 700 includes propulsion units 704, wings 706 and bridge 708.

Although WIG vessel 700, has a different shape than WIG vessel 100, it includes generally similar parts and systems and it is functioning and operated in similar ways to WIG vessel 100.

WIG vessel 700 may be operated by crew from the bridge 708 or it may be remote controlled and/or autonomous.

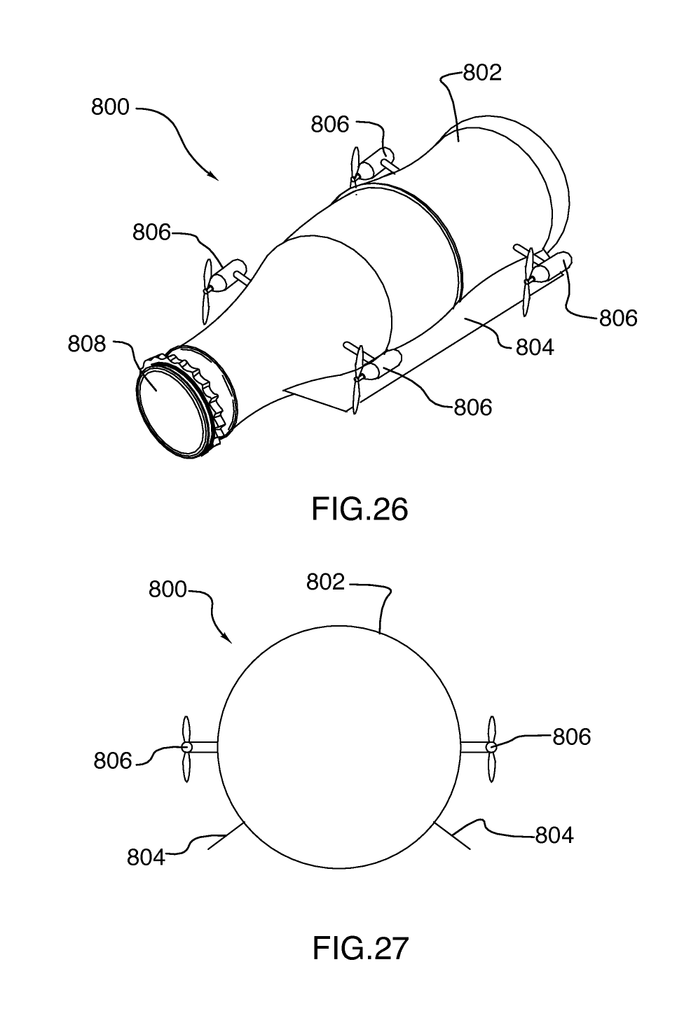

In another embodiment, seen in FIG. 26, a perspective view and FIG. 27 a rear view, WIG vessel 800, with a hull 802 in the shape of a bottle that has wings 804, propulsion units 806 and a bridge 808.

Although WIG vessel 800 is bottle shaped it includes generally similar parts and systems and is functioning and operated in similar ways to WIG vessel 100.

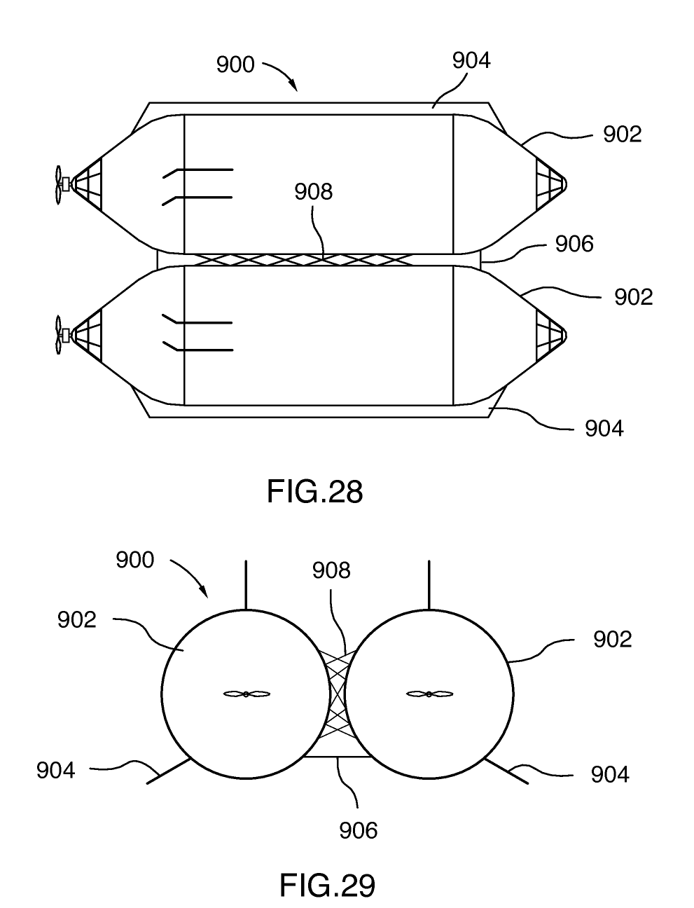

FIG. 28 is a top plan view of yet another embodiment, WIG vessel 900, a catamaran with two hulls 902 and three wings 904 and 906. In FIG. 29, a rear view of WIG vessel 900, one wing 904 can be seen attached to starboard side of the starboard hull 902 and another wing 904 is attached to the port side of the port hull 902. A middle wing 906 connects the two hulls 902 and is part of the total wingspan.

A structure 908 further joins the two hulls 902 together. The structure 908 could be a truss or trusses attached to each hull 902 by suitable means.

WIG vessel 900 has means for propulsion, steering and directional stability as well as means for providing partial aerostatic lift. WIG vessel 900 could have freight or passenger compartments and may be operated by crew from a bridge or it may be remote controlled and/or autonomous.

Operation of WIG vessel 900 is generally similar to the operation of WIG vessel 100.

The invention is not limited to the particular embodiments described above in detail. Those skilled in the art will recognize that other arrangements could be devised, for example, using variously-shaped hulls and various materials and methods of attachment. The invention encompasses every possible combination of the various features of each embodiment disclosed. While the invention has been described with reference to specific illustrative embodiments, modifications and variations of the invention may be constructed without departing from the scope of the invention. Many variations and embodiments of the invention are possible and the exemplary embodiments described should not be construed as limitations. The invention should not be defined by the embodiments described but by the appended claims.

I claim:

1. A WIG vessel, comprising:
a hull;
lighter-than-air gas within the hull;
a propulsion system attached to the hull; and
a plurality of wings attached to the hull having a mean chord length of 14 meters or more;
wherein the hull, propulsion system and wings are configured for traveling on water and for traveling in the air in ground effect.

2. The WIG vessel of claim 1, wherein the wings have a mean chord length to mean span ratio less than or equal to one.

3. The WIG vessel of claim 2, wherein the hull comprises a fore conical end portion.

4. The WIG vessel of claim 3, wherein the wings are of uniform thickness.

5. The WIG vessel of claim 1, further comprising one or more gas holding envelopes inside the hull holding the lighter-than-air gas.

6. The WIG vessel of claim 1, wherein the wings are anhedral or a combination of anhedral and dihedral.

7. The WIG vessel of claim 6, wherein the wings comprise endplates.

8. The WIG vessel of claim 1, further comprising an impeller device or blower configured to create an internal pressure in the hull higher than the ambient atmospheric pressure, in order to maintain the shape and rigidity of the hull.

9. The WIG vessel of claim 8, wherein the hull requires no internal structure or bracing to maintain its shape.

10. The WIG vessel of claim 1, further comprising a weight transfer system for transferring weight between the fore and aft of the vessel in order to adjust its pitch.

11. The WIG vessel of claim 10, wherein the weight transfer system comprises a plurality of ballast containers inside the hull, wherein at least one of the ballast containers is located further to the fore of the hull and one further to the aft, wherein the containers are connected and configured for transfer of ballast between the containers in order to change the pitch of the WIG vessel during operation in flight mode.

12. The WIG vessel of claim 1, further comprising a canard-like wing, elevator or vane having a rear end configured for downward rotation from a neutral or horizontal position, wherein downward rotation of the rear end from a neutral or horizontal position causes the fore of the hull to pitch upwards.

13. The WIG vessel of claim 1, further comprising propulsion units and horizontal flaps mounted rear of the propulsion units configured for downward rotation from a neutral horizontal position, wherein the flaps when rotated downwards from the neutral horizontal position deflect thrust from the propulsion units and force the front of the WIG vessel upward.

14. The WIG vessel of claim 1, wherein the hull comprises a fore conical end portion, an aft conical end portion, and a generally cylindrical intermediate portion extending between the fore and aft conical end portions.

15. The WIG vessel of claim 14, wherein the propulsion system is mounted at a fore apex of the fore conical end portion.

16. The WIG vessel of claim 1, wherein the propulsion system comprises a mounting framework secured to a conical aft end of the hull and a propulsion unit connected to the mounting framework, wherein the mounting framework comprises two or more circular-shaped frame portions of decreasing diameter and frame members extending between and connecting the frame portions, creating an open-ended cone of a size such that when the frame portion of greatest diameter is placed over and coincides with the diameter of the conical aft end of the hull, the frame portion of least diameter is located near the aft apex of the hull and each of the frame members is touching the hull.

17. The WIG vessel of claim 1, wherein the propulsion system comprises a propulsion unit and a propulsion mounting framework, wherein the mounting framework has an outer, square-shaped frame portion, an inner, cross-shaped, frame portion attached to the outer frame portion, and a cantilevered pod or outrigger fastened to the cross-shaped frame portion, wherein the propulsion unit is attached to the cantilevered pod or outrigger.

18. The WIG vessel of claim 13, wherein the mounting framework is bowed or curved to closely correspond to the radius of curvature of the hull.

19. The WIG vessel of claim 1, further comprising flexible sleeves attached to the hull at their middle and having hook-and-look fasteners on their ends, wherein the sleeves fasten the wings or propulsion system to the hull by wrapping around frame members.

20. The WIG vessel of claim 1, further comprising a divider or bulkhead inside and attached to the hull and configured to section off the foremost portion of the hull into a bridge.

21. The WIG vessel of claim 20, further comprising an open-ended cone attached to the inside of the hull, shaped to conform to the interior shape of the hull, and forming the perimeter of the bridge, comprising rings connected by a plurality of tubular frame members

22. The WIG vessel of claim 21, wherein the bridge further comprises a floor secured to the open-ended cone, a seat, an access hatch, and instruments and sensors.

23. The WIG vessel of claim 20, further comprising a passenger compartment having a deck or floor, a ceiling, and windows and a passageway extending between the passenger compartment and the bridge.

24. The WIG vessel of claim 1, further comprising a second hull connected to the hull, wherein one of the lifting surfaces extends between the hulls.

25. The WIG vessel of claim 1, wherein the wings have a wing loading of 1.5 kg/m² or less.

26. A WIG vessel for traveling on water and in the air comprising, in combination, a hull containing lighter-than-air gas, wings and means for propulsion.

27. The WIG vessel according to claim 26, wherein the wings has a chord length equal to or longer than the wingspan.

28. The WIG vessel of claim 26, wherein the wings are of uniform thickness.

29. The WIG vessel of claim 26, wherein the means for propulsion includes diesel engines.

30. A method of operating a WIG vessel that includes changing the pitch of the WIG vessel by means of weight transfer.
